(19) United States
(12) Patent Application Publication
(10) Pub. No.: US 2025/0156705 A1
(43) Pub. Date: May 15, 2025

(54) LEARNING APPARATUS AND METHOD, AND TRAINED MODEL

(71) Applicant: KABUSHIKI KAISHA TOSHIBA, Tokyo (JP)

(72) Inventor: Shintaro HARADA, Yokohama Kanagawa (JP)

(73) Assignee: KABUSHIKI KAISHA TOSHIBA, Tokyo (JP)

(21) Appl. No.: 18/815,913

(22) Filed: Aug. 27, 2024

(30) Foreign Application Priority Data
Nov. 10, 2023 (JP) 2023-192264

(51) Int. Cl. G06N 3/08

(52) U.S. Cl. CPC G06N 3/08

(57) ABSTRACT

According to one embodiment, a learning apparatus includes a processor. The processor acquires a first token sequence in which input data is divided into tokens. The processor generates a second token sequence in which noise is added to the first token sequence. The processor calculates a first feature from the first token sequence and a second feature from the second token sequence using a model for extracting features. The processor calculates a transport cost required for approximating the second feature to the first feature. The processor updates the model based on the transport cost.

### CROSS-REFERENCE TO RELATED APPLICATIONS

This application is based upon and claims the benefit of priority from Japanese Patent Application No. 2023-192264, filed Nov. 10, 2023, the entire contents of which are incorporated herein by reference.

### FIELD

Embodiments described herein relate generally to a learning apparatus and method, and a trained model.

### BACKGROUND

To achieve high performance in such a task as document classification or information extraction using a trained model, it is necessary to construct an objective-specific model tailored to a specific objective. In a case where the objective-specific model is constructed, it is common to adopt a two-stage approach, in which a model that has been previously trained on a large publicly available corpus is used as a base model, and then this base model is further trained on a corpus specific to the objective.

Since the objective-specific model inherits the characteristics of the base model, the final performance of the objective-specific model may depend on the performance of the base model. Furthermore, the performance of the base model does not completely contribute to the performance of a downstream objective-specific model, and latent model characteristics that do not show as performance values may affect the performance of the objective-specific model. However, since such latent model characteristics are hard to confirm at the model training stage, it is hard to obtain feedback from users.

### BRIEF DESCRIPTION OF THE DRAWINGS

FIG. 1 is a block diagram showing a learning apparatus according to a first embodiment.

FIG. 2 is a flowchart illustrating an example of the operation of the learning apparatus according to the first embodiment.

FIG. 3 is a diagram showing an example of a transport matrix.

FIG. 4 is a diagram showing an example of a relationship diagram corresponding to the transport matrix.

FIG. 5 is a block diagram showing a learning apparatus according to a second embodiment.

FIG. 6 is a flowchart illustrating an example of the operation of the learning apparatus according to the second embodiment.

FIG. 7 is a diagram showing a display example of a user interface according to the second embodiment.

FIG. 8 is a diagram showing an example of the hardware configuration of a learning apparatus.

### DETAILED DESCRIPTION

In general, according to one embodiment, a learning apparatus includes a processor. The processor acquires a first token sequence in which input data is divided into tokens. The processor generates a second token sequence in which noise is added to the first token sequence. The processor calculates a first feature from the first token sequence and a second feature from the second token sequence using a model for extracting features. The processor calculates a transport cost required for approximating the second feature to the first feature. The processor updates the model based on the transport cost.

Hereinafter, a learning apparatus and method, and a trained model according to the embodiments will be described in detail with reference to the accompanying drawings. In the embodiments described below, elements assigned with the same reference symbols perform the same operations, and redundant descriptions thereof will be omitted as appropriate.

### First Embodiment

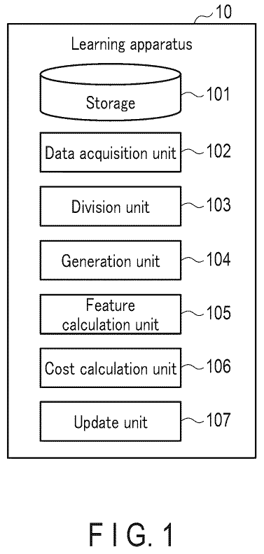

The learning apparatus according to the first embodiment will be described with reference to the block diagram shown in FIG. 1.

The learning apparatus 10 according to the first embodiment includes a storage 101, a data acquisition unit 102, a division unit 103, a generation unit 104, a feature calculation unit 105, a cost calculation unit 106, and an update unit 107.

The storage 101 stores machine learning models, input data used for training the machine learning models, trained models that have been trained, etc. Each machine learning model is a model that can extract features in natural language processing, and is assumed to be a large-scale language model (LLM), such as BERT (Bidirectional Encoder Representations from Transformers) or GPT (Generative Pre-trained Transformer) series, that is GPT-3, GPT-3.5 or GPT-4. It should be noted the machine learning model is not limited to these and may be any model as long as it can serve as a base model for performing preliminary learning prior to downstream tasks. The input data is assumed to be text data, such as sentences. The trained model includes a network layer that processes input data and infers output data.

The data acquisition unit 102 acquires input data.

The division unit 103 divides the input data into tokens and generates a first token sequence.

The generation unit 104 generates a second token sequence by adding noise to the first token sequence.

The feature calculation unit 105 uses a model for extracting features and calculates a first feature from the first token sequence and calculates a second feature from the second token sequence.

The cost calculation unit 106 calculates a transport cost used for approximating the second feature to the first feature. The transport cost is a cost required for returning the second token sequence to the first token sequence. The update unit 107 updates the model based on the transport cost and obtains a trained model.

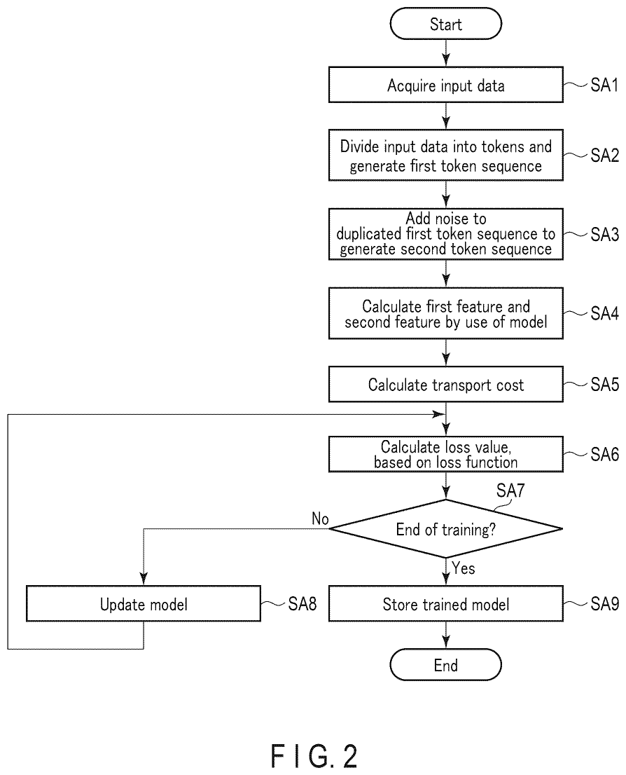

Next, an example of the operation of the learning apparatus 10 according to the first embodiment will be described with reference to the flowchart of FIG. 2.

In step SA1, the data acquisition unit 102 acquires input data from the storage 101, for example. The input data is assumed to be, for example, a sentence that can be obtained from a corpus. It should be noted that the data acquisition unit 102 does not have to acquire input data from the storage 101; it may acquire input data from an external server that stores a large-scale corpus.

In step SA2, the division unit 103 divides the input data into tokens and generates a first token sequence. The input data may be divided into tokens in a general method, using a tokenizer, in units of morphemes or in units of words. Additionally, tokens that are hard to process, such as symbols and numbers, may be normalized or removed. The division unit 103 may use a tokenizer that enables detailed division and divide the input data into still finer-grain tokens.

In step SA3, the generation unit 104 duplicates the first token sequence, and adds at least one of masking (filling) processing and rearrangement processing to the duplicated token sequence as noise. In the masking processing, “input length of token sequence×p {mask}” tokens can be masked in accordance with the probability value p {mask}. Specifically, if the probability value P is “0.1,” 10% of the tokens in the token sequence are masked. Thus, in the case where the token sequence is formed of 10 tokens, one token is masked.

In the rearrangement processing, the order of “input length of token sequence×p_{shuffle}” tokens can be changed in accordance with the probability value p {shuffle}. Specifically, if the probability value is “0.5,” the order of 50% of the tokens in the token sequence is changed. In the case where the order of 10 tokens is “1, 2, 3, 4, 5, 6, 7, 8, 9, 10,” the order is changed, for example, to “1, 2, 3, 6, 4, 5, 7, 10, 9, 8.”

In this manner, a second token sequence is generated by applying at least one of the masking processing and the rearrangement processing, that is, by adding noise.

In step SA4, the feature calculation unit 105 uses a model for extracting features and extracts a first feature from the first token sequence and a second feature from the second token sequence. The model may be any type of model as long as it can extract a feature representation. For example, using BERT, a vector of the feature representation is extracted as the first feature for each token of the first token sequence, and a vector sequence of the first token sequence is generated. It should be noted that the second feature may be generated in a manner similar to that of the first feature.

In step SA5, the cost calculation unit 106 calculates a transport cost required for returning the second token sequence, which is a token sequence with added noise, to the first token sequence, which is a token sequence without the noise. Since the second token sequence is the same token sequence as the first token sequence before noise is added, the learning apparatus 10 can grasp the correspondence between them. The cost calculation unit 106 may calculate the transport cost by solving the processing of returning the second token sequence to the first token sequence as an optimal transport problem. Since a general method can be used for solving the optimal transport problem, a detailed description on this matter is omitted.

In step SA6, the update unit 107 calculates a loss value, based on a loss function including the transport cost. For example, if the model is BERT, use is made of a loss function L_{MLM} pertaining to MLM (Masked Language Modeling), which is a fill-in-the-blank problem, a loss function L_{NSP} pertaining to NSP (Next Sentence Prediction), which predicts a next sentence, and a loss function L_{OP} pertaining to the transport cost, and the loss function L of the equation (1) may be used as the loss function of the entire model.

L=L_{MLM}+L_{NSP}+L_{OP} (1)

A loss value may be calculated using only the loss function L_{OP} pertaining to the transport cost as the loss function L of the entire model. Alternatively, the weighted sum of the loss functions L_{MLM}, L_{NSP} and L_{OP} may be used as the loss function L of the entire model.

In step SA7, the update unit 107 determines whether the model training ends. For example, it is determined if the loss value is less than or equal to a threshold value and whether the loss value has converged. In the case where the loss value is less than or equal to the threshold value and has converged, it is assumed that the model training has ended and the process moves on to step SA9. On the other hand, in the case where the loss value is larger than the threshold or the loss value has not yet converged, the process moves on to step SA8. Although an example of determining the end of training based on the loss value is mentioned here, this is not restrictive, and a general training end determination method, such as that adopted in the training of a model using a loss function L, may be used by detecting whether training has been repeated for a predetermined number of epochs.

In step SA8, the update unit 107 updates the model by updating such parameters as the weight and bias of the model. Thereafter, the process returns to step SA6 and similar processes are repeated.

In step SA9, the storage 101 stores the trained model.

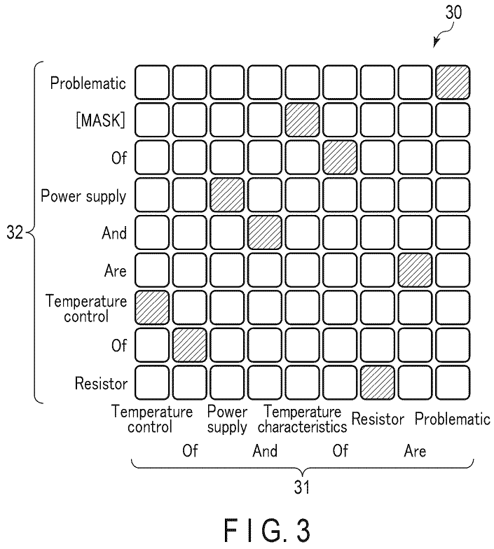

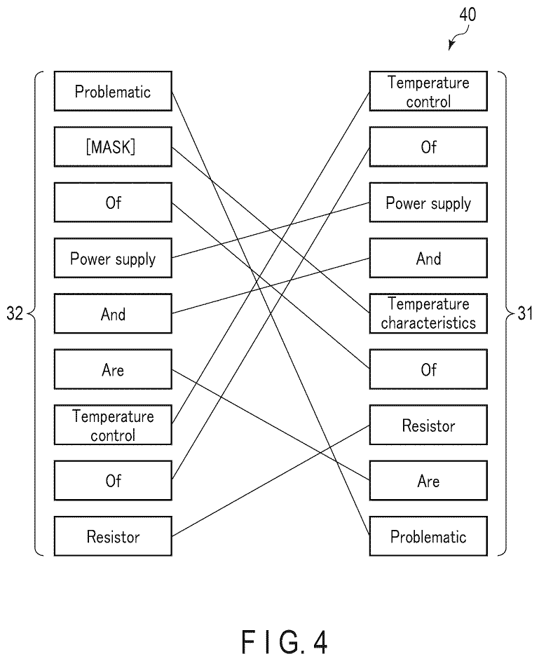

Next, an example of the transport cost will be described with reference to FIG. 3 and FIG. 4.

FIG. 3 is a transport matrix 30 (referred to as an alignment matrix as well) in which the second token sequence 32 is a vertical sequence and the first token sequence 31 is a horizontal sequence, and combinations of the correspondences are shown in a matrix format.

In FIG. 3, the first token sequence 31 is assumed to be “power supply of temperature control and resistor of temperature characteristics are problematic” and the second token sequence 32 is assumed to be “problematic [MASK] of power supply and are temperature control of registor.” It is assumed that the first token sequence 31 and the second token sequence 32 have been converted into vector sequences of features. The underscore “_” in each of the above token sequences is a special character indicating a break between tokens.

In an output result of the model, grids at which the correspondences between the tokens in the first token sequence 31 and the tokens in the second token sequence 32 have the highest probability are indicated with diagonal lines. For example, the calculation result of the feature values of the model indicates that “[MASK]” in the second token sequence 32 has been regarded as corresponding to the token “temperature characteristics” in the first token sequence 31. FIG. 3 shows the transport matrix 30 as grids for convenience of description, and probability values are associated with the respective grids.

FIG. 4 is a relationship diagram 40 in which correspondences are shown in units of tokens so that the transport matrix 30 shown in FIG. 3 can be easy to understand visually. Specifically, in FIG. 4, the second token sequence 32 is shown as the left column, the first token column 31 is shown as the right column, and corresponding tokens are connected with lines.

In the case where the distance between the feature representation of the feature xi of the token in the first token sequence 31 and the feature representation of the feature y, of the token in the second token sequence 32 is defined as a transport amount and where similarity between the feature representations is calculated using a cosine similarity (COSₛᵢₘ(Xᵢ, Yⱼ)), the transport amount can be expressed as: transport amount=1−COSₛᵢₘ (Xᵢ, Yⱼ). It should be noted that i and j are natural numbers of 1 or more, and xi and y, are vectors.

That is, similar feature representations have a small transport amount, and dissimilar feature representations have a large transport amount. In the present embodiment, the second token sequence 32 is generated based on the first token sequence 31, so that the transport path for returning the second token sequence 32, which is a noise-added token sequence, to the first token sequence 31, which is a token sequence with no added noise, can be grasped by the learning apparatus 10. Therefore, the cost calculation unit 106 can solve an optimal transport problem, based on the transport amount between the feature representations of the first token sequence 31 and the second token sequence 32, and can therefore calculate an optimal transport path, thereby calculating a transport cost and a transport matrix.

In the example shown in FIG. 3, as described above, [MASK] in the first token sequence 31 and “temperature characteristics” in the second token sequence 32 look different from each other (character strings themselves are different), but are regarded as corresponding to each other in the generation of the transport matrix. A model that can generate correct correspondence in this manner is a highly accurate model that can read the context correctly.

According to the first embodiment described above, a model is applied to the second token sequence that is generated by adding at least one of masking noise and rearranging noise to the first token sequence that is input. As an output result of the model, a correspondence between token features (feature vectors) is output. Based on the correspondence, an optimal transport problem for returning the second token sequence to the first token sequence is solved, and a transport cost is calculated. The model is updated and trained, using a loss function including the calculated transport cost.

Thus, the overall structure can be reflected in the loss function, and the model can be trained, with the contextual information being taken into account and the entire token being paid attention to. Therefore, the quality of a feature representation can be quantitatively evaluated from the loss value, and qualitative evaluation can be added from a transport matrix obtained as a by-product of the optimal transport problem. As a result, a base model that is robust to noise can be constructed. In other words, the performance of the base model can be improved for downstream objective models, such as a similar failure document search and a failure component extraction.

### Second Embodiment

The second embodiment differs from the first embodiment in that a transport matrix obtained by solving an optimal transport problem is presented to the user, feedback information is obtained from the user, and the feedback information is used for model training.

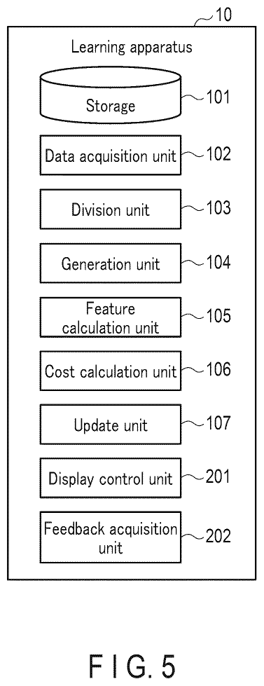

A learning apparatus 10 according to the second embodiment will be described with reference to the block diagram shown in FIG. 5.

The learning apparatus 10 according to the second embodiment includes a storage 101, a data acquisition unit 102, a division unit 103, a generation unit 104, a feature calculation unit 105, a cost calculation unit 106, an update unit 107, a display control unit 201, and a feedback acquisition unit 202.

The display control unit 201 controls a user interface (UI) in such a manner that the user operates a display device (not shown) to display transport matrices, transport costs, etc.

The feedback acquisition unit 202 acquires feedback information by receiving input values and operations which the user inputs via the UI for model training.

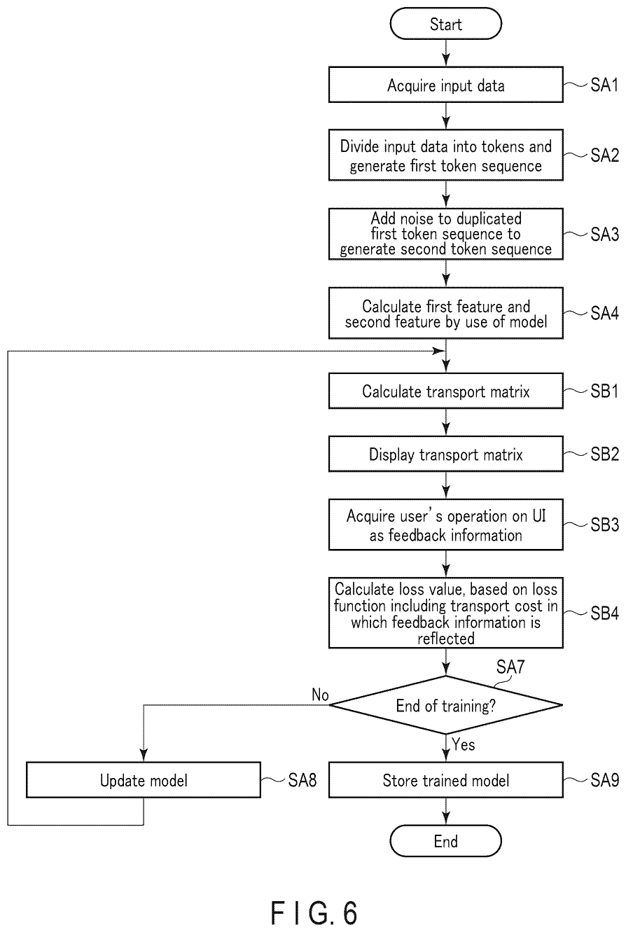

Next, an example of the operation of the learning apparatus 10 according to the second embodiment will be described with reference to the flowchart of FIG. 6.

Step SA1 to step SA4 and step SA7 to step SA9 are similar to those of FIG. 2.

In step SB1, the cost calculation unit 106 calculates a transport matrix. For example, a transport matrix obtained by solving an optimal transport problem can be used.

In step SB2, the display control unit 201 displays the transport matrix.

In step SB3, the feedback acquisition unit 202 acquires, as feedback information, at least one of the input value and the operation which the user inputs for the transport matrix via the UI.

In step SB4, the cost calculation unit 106 calculates a transport cost, based on the transport matrix that reflects the feedback information. The cost calculation unit 106 calculates a loss value, based on a loss function including the transport cost.

Thereafter, in step SA7, it is determined whether the loss value is less than or equal to a threshold value. In a case where the loss value is larger than the threshold value, the process returns to step SB1 after the model is updated in step SA8, and the same process is repeated.

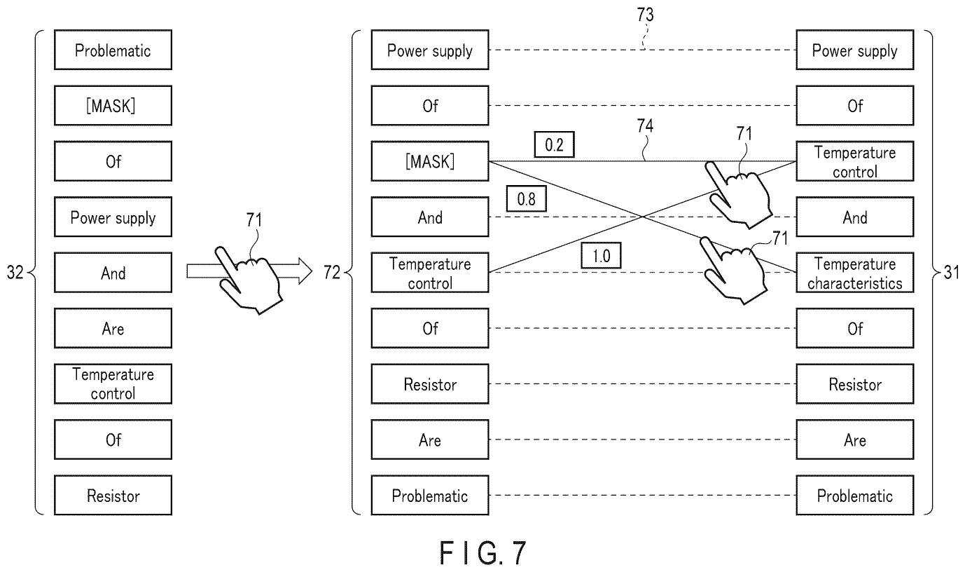

Next, an example of what is displayed on the UI by the display control unit 201 of the second embodiment will be described with reference to FIG. 7.

The token sequence shown on the left side of FIG. 7 is a token sequence to which noise is added, and it is assumed here that the second token sequence 32 is displayed. The user drags and drops each of the tokens of the second token sequence 32 on the UI, using the cursor 71, rearranges the token sequence in the order of the token sequence that does not include noise expected by the user, and obtains a user-specified token 72.

Specifically, the second token sequence 32 “problematic [MASK] of power supply and are temperature control of registor” is rearranged in the token order of the first token sequence 31, with the token “[MASK]” being included, and a user-specified token is generated thereby. In other words, it is assumed that the token sequence is corrected to read “[MASK] of power supply and temperature control of resistor are problematic.” By this correction, the difference between the token correspondence indicated by the learning apparatus 10 and the token correspondence expected by the user can be measured. Furthermore, since the learning apparatus 10 and the user can understand differences in recognition of the token correspondences, the differences can be used to identify a to-be-corrected portion in a model for the downstream task.

The center of FIG. 7 and the right side of FIG. 7 show correspondences between the user-specified token 72 and the first token sequence 31. The correspondences inferred by the learning apparatus 10 are shown by broken-line paths 73. The user can use the cursor 71 on the UI and correct the paths between the tokens. The correspondences corrected by the user are shown by solid-line paths 74.

In the example shown in FIG. 7, the learning apparatus 10 infers that the token “temperature control” in the user-specified tokens 72 corresponds to the token “temperature characteristics” in the first token sequence 31, and these tokens are connected by the path 73. The user recognizes that the correspondence between the tokens is incorrect, and in order to correct the correspondence, the user connects the token “temperature control” in the user-specified tokens 72 to the token “temperature control” in the first token sequence 31, and a path 74 is created thereby. The feedback acquisition unit 202 is only required to acquire the processing result related to the correction as feedback information.

It is also assumed that the learning apparatus 10 infers that the token “[MASK]” in the user-specified tokens 72 and the token “temperature control” in the first token sequence 31 correspond to each other, and that they are connected by the path 73. If the user recognizes that the correspondence between the tokens is incorrect but is tolerable, the user can set a plurality of correspondences. In this example, the user connects the token “[MASK]” and the token “temperature control” by the path 74, and sets the accuracy of the correspondence to “0.2.” Further, the user connects the token “[MASK]” to the token “temperature characteristics” by the path 74, and sets the accuracy of the correspondence to “0.8.”

In this manner, even if the correspondence between tokens presented by the learning apparatus 10 is incorrect, it may be adopted as a correct one, or a plurality of correspondences may be set as long as the incorrect correspondence is tolerable and can be used in objective models used thereafter. Similarly, if the correspondence between tokens is correct, it may be corrected as an error if it is intolerable in consideration of the use in the subsequent objective models.

According to the second embodiment described above, the transport matrix is presented to the user and feedback information is obtained from the user. By referring to the transport matrix displayed on the UI, the user can provide appropriate feedback while simultaneously checking the training status of the model and how the intended training is in progress. Thus, the learning apparatus can perform optimal training while simultaneously confirming latent model characteristics at the training stage, through qualitative evaluation based on the feedback. As a result, the performance of the base model can be improved.

It should be noted that the user does not have to input all items presented on the UI, and the feedback acquisition unit 202 can accept and process only the items that are input and presented by the user.

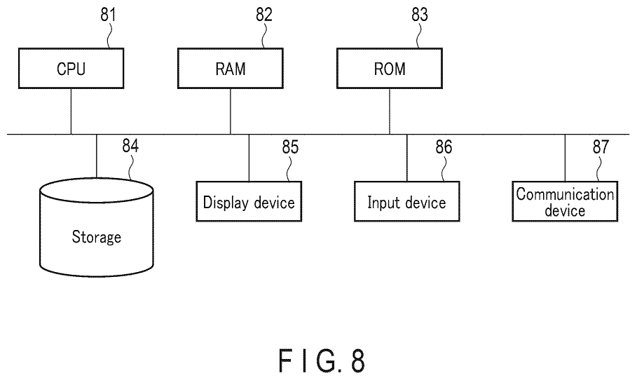

Next, an example of the hardware configuration of the learning apparatus 10 according to the above-described embodiments is shown in the block diagram of FIG. 8.

The learning apparatus 10 includes a CPU (Central Processing Unit) 81, a RAM (Random Access Memory) 82, a ROM (Read Only Memory) 83, a storage 84, a display device 85, an input device 86, and a communication device 87. These elements are coupled to each other by a bus.

The CPU 81 is a processor that executes arithmetic processing, control processing, etc. according to a program. The CPU 81 uses a predetermined area of the RAM 82 as a work area, and executes the process of each unit of the above-mentioned learning apparatus 10 in cooperation with programs stored in the ROM 83, the storage 84, etc. It should be noted that each process of the learning apparatus 10 may be executed by one processor, or may be executed in a distributed manner by a plurality of processors.

The RAM 82 is such a memory as an SDRAM (Synchronous Dynamic Random Access Memory). The RAM 82 functions as a work area of the CPU 81. The ROM 83 is a memory that stores programs and various information in a non-rewritable manner.

The storage 84 is a device that writes and reads data to and from a magnetic recording medium such as an HDD (Hard Disc Drive), a semiconductor storage medium such as a flash memory, a magnetically recordable storage medium such as an HDD, an optically recordable storage medium, or the like. The storage 84 writes and reads data to and from the storage medium under the control of the CPU 81.

The display device 85 is such a display device as an LCD (Liquid Crystal Display). The display device 85 displays various information, based on display signals supplied from the CPU 81.

The input device 86 is such an input device as a mouse or a keyboard. The input device 86 receives information entered by the user as an instruction signal, and outputs the instruction signal to the CPU 81.

The communication device 87 communicates with external devices via a network under the control of the CPU 81.

The instructions included in the steps described in the foregoing embodiments can be implemented based on a software program. A general-purpose computer system can store the program beforehand and read the program in order to attain the same advantages as the above-described learning apparatus. As a program executable by a computer, the instructions described in the above embodiments are stored in a magnetic disc (a flexible disc, a hard disc, or the like), an optical disc (CD-ROM, CD-R, CD-RW, DVD-ROM, DVD+R, DVD+RW, Blu-ray (registered trademark) disc), a semiconductor memory, or a storage medium similar to these. As long as the storage medium is readable by a computer or by a built-in system, any storage format can be used. An operation similar to the operation of the learning apparatuses of the above-described embodiments can be realized if a computer reads a program from the storage medium, and executes the instructions written in the program on the CPU based on the program. Needless to say, the computer may acquire or read the program by way of a network. Furthermore, an operating system (OS) working on a computer, database management software, MW (middleware) of a network, etc. may execute part of the processing for realizing the embodiments, on the basis of instructions of a program that is installed in the computer or the built-in system from the storage medium.

Moreover, a storage medium employed in the embodiments is not limited to a medium provided independently of a computer or a built-in system, and a storage medium storing or temporarily storing a program downloaded through a LAN, the Internet, etc. can also be employed in the embodiments.

In addition, the storage medium is not limited to one storage medium, and the processes of the embodiments may be performed using multiple storage media. In this case as well, the storage media are within the scope of the embodiments and may have any configuration.

The computer or built-in system in the embodiments is used to execute each process of the embodiments, based on a program stored in a storage medium, and may be an apparatus consisting one of a PC, a microcomputer or the like, or a system in which a plurality of apparatuses are coupled through a network.

The computer in the present embodiment is not limited to a PC; it may be an arithmetic processing unit, a microcomputer, etc. included in an information processor. The “computer” is a general name of a device or an apparatus that can realize the functions of the embodiments according to a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning apparatus comprising a processor configured to:
acquire a first token sequence in which input data is divided into tokens;
generate a second token sequence in which noise is added to the first token sequence;
calculate a first feature from the first token sequence and a second feature from the second token sequence using a model for extracting features;
calculate a transport cost required for approximating the second feature to the first feature; and
update the model based on the transport cost.

2. The apparatus according to claim 1, wherein the processor is configured to calculate the transport cost, based on a transport matrix pertaining to an optimal transport problem.

3. The apparatus according to claim 1, wherein the processor is configured to execute at least one of token rearranging processing and token masking processing as processing for adding the noise.

4. The apparatus according to claim 1, wherein the processor is configured to determine whether or not training of the model has ended, based on a loss function including the transport cost.

5. The apparatus according to claim 1, wherein the processor is further configured to cause a display device to display to a user a transport matrix relating to calculation the transport cost.

6. The apparatus according to claim 5, wherein the processor is further configured to:
acquire from the user feedback information pertaining to training of the model based on the transport matrix,
calculate a new transport cost, based on the feedback information.

7. A learning method comprising:
acquiring a first token sequence in which input data is divided into tokens;
generating a second token sequence in which noise is added to the first token sequence;
calculating a first feature from the first token sequence and a second feature from the second token sequence by using a model for extracting features;
calculating a transport cost required for approximating the second feature to the first feature; and
updating the model based on the transport cost.

8. The method according to claim 7, wherein the calculating the transport cost is calculating the transport cost based on a transport matrix pertaining to an optimal transport problem.

9. The method according to claim 7, wherein the generating the second token sequence processor is executing at least one of token rearranging processing and token masking processing as processing for adding the noise.

10. The method according to claim 7, wherein the updating the model is determining whether or not training of the model has ended, based on a loss function including the transport cost.

11. The method according to claim 7, further comprising displaying to a user a transport matrix relating to calculation the transport cost.

12. The method according to claim 11, further comprising:
acquiring from the user feedback information pertaining to training of the model based on the transport matrix; and
calculating a new transport cost, based on the feedback information.

13. A trained model comprising a network layer that processes input data and infers output data, the trained model being trained by:
a generation step of generating a second token sequence in which noise is added to a first token sequence;
a feature calculation step of calculating a first feature from the first token sequence and a second feature from the second token sequence by using a model for extracting features;
a cost calculation step of calculating a transport cost required for approximating the second feature to the first feature; and
an update step of updating the model based on the transport cost,
the trained model causing a computer to input the input data to the network layer to which an updated parameter is assigned and to infer the output data.
